(19) United States
(12) Patent Application Publication
(10) Pub. No.: US 2006/0218360 A1
(43) Pub. Date: Sep. 28, 2006

(54) Method, apparatus and program storage device for providing an optimized read methodology for synchronously mirrored virtual disk pairs

(76) Inventor: Todd R. Burkey, Savage, MN (US)

Correspondence Address: Crawford Maunu PLLC;Suite 390, 1270 Northland Drive, St. Paul, MN, 55120, US

(21) Appl. No.: 11/086,079

(22) Filed: Mar. 22, 2005

(51) Int. Cl. G06F 13/00

(52) U.S. Cl. 711/154

(57) ABSTRACT

A method, apparatus and program storage device for providing an optimized read methodology for synchronously mirrored virtual disk pairs are disclosed. A VDisk to use for read operations is determined based on loading of synchronously mirrored VDisk pairs. Based on the loading, the determined request is used to satisfy the read operation.

### BACKGROUND OF THE INVENTION

1. Field of the Invention

This invention relates in general to data storage systems, and more particularly to a method, apparatus and program storage device for providing an optimized read methodology for synchronously mirrored virtual disk pairs.

2. Description of Related Art

A storage area network is a dedicated, high-speed, scalable network of servers and storage devices designed to enhance the storage, retrieval, availability, and management of data. Storage area network technology significantly increases access, performance, and manageability of data storage, while decreasing total cost of ownership. A SAN allows multiple hosts to directly access physically shared devices. This is accomplished through a Fibre Channel (FC) fabric installed between servers and storage devices, creating a storage data network separate from local area networks (LANs). In a fabric, one or more switches are used to allow any-to-any connectivity between attached hosts and storage. Fabric topologies can be specifically tailored to provide improved data consolidation and management, high-speed data access, continuous data availability, and/or disaster protection.

With traditional direct-attached storage, wherein each server has its own storage, it is often very difficult to manage diverse storage resources, perform adequate capacity planning, and ensure appropriate levels of data protection. By consolidating storage, these tasks become much simpler. SAN management tools make it possible to view storage globally and to perform many common management tasks. High-Speed Data Access storage area networks readily accommodate applications that require high-speed data access. A server or storage system can be configured with multiple FC connections to the storage area network fabric to optimize performance.

A storage area network can be designed with no single points of failure to ensure the highest possible data availability. In such a design, each storage system and server has redundant connections, and multiple switches are used along with highly reliable RAID storage or mirrored storage. In many cases, two independent storage area network fabrics are used. Availability is ensured because all connections to a storage area network are used in parallel with the load balanced between them. If one connection fails, its workload can be transparently redistributed across the remaining connections. A storage area network designed for high data availability is also well suited for the deployment of high-availability (HA) applications. Two or more systems are configured with access over the storage area network to the same physical storage. The storage is partitioned such that, in normal operation, a portion of the storage is dedicated for the exclusive use of each server and its applications. If one server fails, another automatically assumes control of its storage and restarts critical applications so that application downtime is minimized.

The flexibility that allows a storage area network to deliver data and application availability also makes it easier to provide protection against disaster. Synchronous or asynchronous copies of data can be mirrored to a remote site. In case of an emergency, critical operations can be restored very quickly at the remote facility. Storage area networks support long cable runs, thereby enabling support of remote sites in the same metropolitan area. In such configurations, storage can be synchronously mirrored between sites to allow high availability and disaster recovery to be combined in one solution. By mirroring storage and distributing HA servers between sites, applications can be made tolerant to disasters that take down an entire location, as well as to the normal equipment and software failures against which HA normally protects

Virtualization is the process of creating a pool of storage that can be split into virtual disks (VDisks). VDisks are visible to the host systems that use them and provide a common way to manage SAN storage. A VDisk is an object that appears as a physical disk drive to a guest operating system, even though it is in actuality composed of one or more raid arrays that are striped in whole or in part over multiple physical disks. Virtualization can be performed at three primary levels: the host level, the storage device level, and the network level.

Host-based virtualization has long been available in the form of logical volume managers. Logical volumes, also referred to as virtual disks, are essentially pointers to physical storage, such as drives or Logical Unit Numbers (LUNs). A LUN is a SCSI-based identifier for a logical unit on a device such as a disk array.

In host-based virtualization, software presents a view to the host server in which disks from multiple storage arrays appear as a single virtual pool. Logical volume managers can eliminate the need to display multiple devices to the user. When storage requirements expand, logical volume managers can perform mapping to free disk space (block aggregation) in a manner that's transparent to users. A primary benefit of this approach is that applications can remain online while file system and volume sizes are adjusted. Also, implementation of host-based virtualization doesn't require the purchase of additional hardware. On the downside, host-based virtualization can result in performance bottlenecks at the server, where CPU cycles are consumed by the processing efforts involved. In addition, virtualization software must be installed on each server. There are also limits on the scalability of this approach.

Virtualization can also be implemented within devices, such as storage arrays, using virtualization software residing inside the array. This software enables the construction of storage pools across multiple arrays. With storage-based virtualization, the logical storage units are mapped to the physical devices via algorithms or using a table-based approach. Essentially, volumes become independent of the devices they reside on. Depending on the solution used, storage-based virtualization capabilities can include RAID, mirroring, disk-to-disk replication, and the creation of point-in-time snapshots. While storage-based virtualization yields favorable results for individual vendors' arrays and is relatively easy to manage, systems based on this approach are typically proprietary, and are thus limited when it comes to interoperability with other vendors' hardware and software.

Network-based virtualization is a relatively recent development in the storage industry. In network-based virtualization, the virtualization functions are executed within the network itself, as opposed to within the host servers or storage devices. Today, that network is typically a Fibre Channel SAN, although virtualization products are available for IP SANs as well. In network-based virtualization, the primary virtualization functions can be executed in switches or routers, appliances, or servers. Network-based virtualization can be either in-band or out-of-band.

RAID (Redundant Array of Independent Disks) is a collection of specifications that describe a system for storing data on multiple array disks to ensure availability and performance. Each RAID level provides a different method for organizing the disk storage. These methods are referred to by number, such as RAID 0 or RAID 5. For example, RAID Level 0 involves the striping of data in equal-sized segments across the array disks. RAID 0 does not provide data redundancy. RAID 1 is the simplest form of maintaining redundant data. In RAID 1, data is mirrored or duplicated on one or more drives. If one drive fails, then the data can be rebuilt using the mirror. RAID 3 provides data redundancy by using data striping in combination with parity information. Data is striped across the array disks, with one disk dedicated to parity information. If a drive fails, the data can be reconstructed from the parity. Similar to RAID 3, RAID 5 provides data redundancy by using data striping in combination with parity information. Rather than dedicating a drive to parity, however, the parity information is striped across all disks in the array. RAID 50 is a concatenation of RAID 5 across more than one three-drive spans. For example, a RAID 5 array that is implemented with three drives and then continues on with three more array drives would be a RAID 50 array. RAID 10 combines mirrored drives (RAID 1) with data striping (RAID 0). With RAID 10, data is striped across multiple drives. The set of striped drives is then mirrored onto another set of drives. RAID 10 can be considered a mirror of stripes.

Mirroring involves the duplication of data on two array disks. Mirroring provides data redundancy by using a copy (mirror) of the RAID group to duplicate the information contained in the RAID group. The mirror is located on a different array disk. If one of the array disks fails, the system can continue to operate using the unaffected disk. Both drives contain the same data at all times. Either drive can act as the operational drive. A mirrored RAID group is comparable in performance to a RAID-5 group in read operations but faster in write operations. For example, a RAID 10 system could include 10 disks that are mirrored in pairs to give five virtual disks, and then those five virtual disks would be striped. This gives very high performance combined with complete redundancy, particularly if the mirrored disks are on separate controllers.

Because virtual disks may be viewed as objects as opposed to simply a reference number (LUN) for a raid array, a virtual disk is an object that can be added to (expanded), copied, and mirrored in much the same manner as physical drives are handled at the raid level. The degree of virtualization also allows for unique and new techniques that are not really pertinent to the rest of the storage industry yet.

The current state of the art in the area of mirroring virtual disks is to perform read/write operations to the source of a mirror and then simply perform write operations to the destination of a mirrored RAID or VDisk. The obvious problem in such a design is that physical disks that contain the destination RAIDs of mirror sets will see only write operations as a result of the mirroring operations while the physical disks that are part of the source raid arrays will see both reads and writes. Because a majority of operations in storage systems are read operations, this tends to cause more of a bottleneck on the source VDisks because their physical disks see more activity. Also, since multiple virtual disks are striped over the same physical disks, it is very likely that other virtual disk read and write operations will impact the performance of some of the physical disks that comprise either the source or destination physical disks of another virtual disk mirror set, inducing further performance complications.

To overcome this problem, storage managers must often make very careful choice of which physical disks raids are striped over, based on predicted usage patterns. However, this tends to be very one-shot, i.e., get it right the first time, and can't account for changing requirements or increased complexity as more and more raids are striped over the same physical disks. Also, as databases get larger and backup times take longer, the trend in the industry is to provide perform more continuous backup operations for disaster recovery processes.

It can be seen that there is a need for method, apparatus and program storage device for providing an optimized read methodology for synchronously mirrored virtual disk pairs.

### SUMMARY OF THE INVENTION

To overcome the limitations in the prior art described above, and to overcome other limitations that will become apparent upon reading and understanding the present specification, the present invention discloses a method, apparatus and program storage device for providing an optimized read methodology for synchronously mirrored virtual disk pairs.

The present invention solves the above-described problems by determining a VDisk to use for read operations based on loading of all physical disks used by the synchronously mirrored VDisk pairs. Based on the loading, either a single read operation will be issued to the optimal virtual disk in order to satisfy the read operation, or multiple read operations may be issued to each VDisk of the mirror pair in order to retrieve the read data in the fastest possible manner.

A method in accordance with the principles of the present invention includes determining a virtual disk to use for read operations based on loading of synchronously mirrored virtual disk pairs and based on the loading, using the determined request to satisfy the read operation.

In another embodiment of the present invention, a controller for performing read operations in a synchronously mirrored pair of virtual disks is disclosed. The controller includes memory for storing data and program operation instructions thereon and a processor, coupled to the memory, the processor being configured to determine a virtual disk to use for read operations based on loading of synchronously mirrored virtual disk pairs and based on the loading, to use the determined request to satisfy the read operation.

In another embodiment of the present invention, a storage system is disclosed. The storage system includes a pool of storage devices and a controller, coupled to the pool of storage devices, the controller virtualizing physical disks in the pool of storage devices as virtual disks, a first virtual disk being synchronously mirrored to a second virtual disk, wherein the controller determines whether to use the first or second virtual disk for read operations based on loading of the first and second virtual disk and based on the loading, uses the determined request to satisfy the read operation.

In another embodiment of the present invention, a program storage device having program instructions executable by a processing device to perform operations for performing read operations in a synchronously mirrored pair of virtual disks is disclosed. The operations include determining a virtual disk to use for read operations based on loading of synchronously mirrored virtual disk pairs and based on the loading, using the determined request to satisfy the read operation.

In another embodiment of the present invention, another controller for performing read operations in a synchronously mirrored pair of virtual disks is disclosed. This controller includes means for storing data and program operation instructions thereon and means, coupled to the means for storing data and program operation instructions, for determining a virtual disk to use for read operations based on loading of synchronously mirrored virtual disk pairs and based on the loading, for using the determined request to satisfy the read operation.

In another embodiment of the present invention, another controller for performing read operations in a synchronously mirrored pair of virtual disks is disclosed. This controller includes memory for storing data and program operation instructions thereon and a processor, coupled to the memory, the processor being configured to issue the read request to both source and destination VDisks simultaneously and then process whichever read operation completes or, based on queue management, appears to be going to complete first These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage area network according to an embodiment of the present invention;

FIG. 2 is a block diagram of a storage system implementing an optimized read methodology for synchronously mirrored virtual disk pairs according to an embodiment of the present invention;

FIG. 3 is a block diagram of synchronously mirrored virtual disk pairs that experience a bottleneck because of the read operations;

FIG. 4 is a flow chart of a method for providing an optimized read methodology for synchronously mirrored virtual disk pairs according to an embodiment of the present invention;

FIG. 5 is flow chart of a method for providing an optimized read methodology for synchronously mirrored virtual disk pairs according to an embodiment of the present invention;

FIG. 6 is flow chart of a method for providing an optimized read methodology for synchronously mirrored virtual disk pairs according to an embodiment of the present invention; and

FIG. 7 illustrates a controller or system is a storage system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing an optimized read methodology for synchronously mirrored virtual disk pairs. A VDisk to use for read operations is determined based on loading of synchronously mirrored VDisk pairs. Based on the loading, the determined request is used to satisfy the read operation.

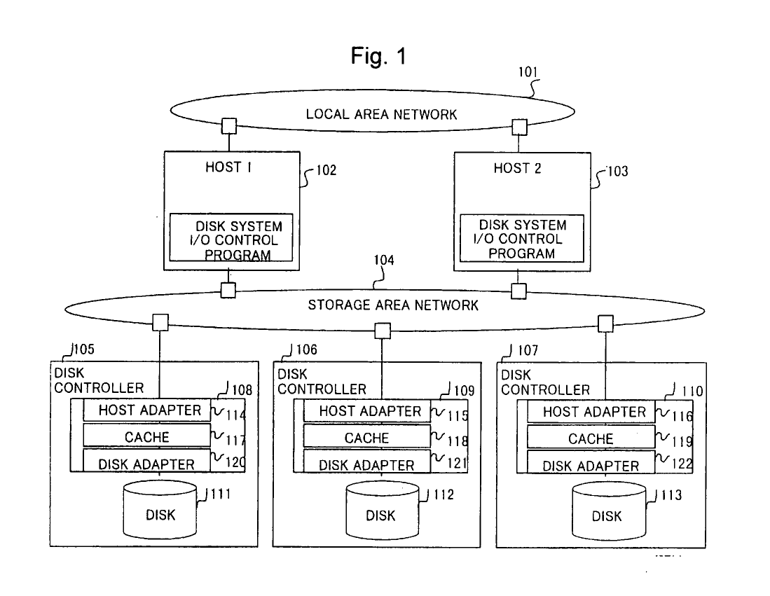

FIG. 1 illustrates a storage area network according to an embodiment of the present invention. A local area network 101, and host computers 102, 103 are coupled to disk systems 105, 106, 107 through the storage area network 104. The local area network 101 is used for communications between the host computers 102, 103 and the storage area network 104 is used for data communications between the disk systems 105, 106, 107 and the host computers 102, 103, or the disk systems 105, 106, 107.

The disk systems 105, 106, 107 are configured with disk controllers 108, 109, 110 and disk sets 111, 112, 113. The disk controllers 108, 109, 110 interpret and perform I/O requests issued from the host computers 102, 103, and disks 111, 112, 113 store data transferred from the host computers 102, 103. The disk controllers 108, 109, 110 are configured with host computer adapters 114, 115, 116, and disk adapters 120, 121, 122. The host computer adapters 114, 115, 116 receive and interpret commands issued from the host computers 102, 103. The disk adapters 120, 121, 122 perform input and output for the disks 111, 112, 113 based on the interpretation performed by the host computer adapters 114, 115, 116.

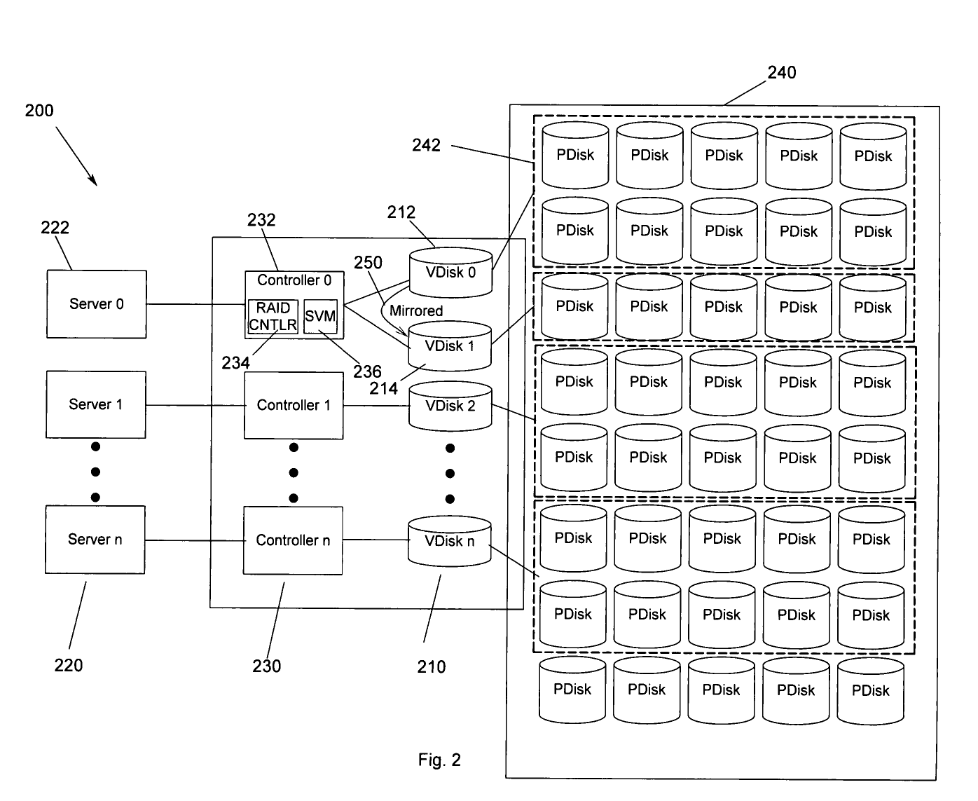

FIG. 2 is a block diagram of a storage system 200 implementing an optimized read methodology for synchronously mirrored virtual disk pairs according to an embodiment of the present invention. In FIG. 2, virtual disks 210 are assigned to servers 220 by associating the virtual disks 210 with clusters implemented via controllers 230. In FIG. 2, Server 0 222 is assigned to controller 0 232 for Cluster 0 as is virtual disk 0 212. Virtual disk 0 212 is striped across 10 physical disks 242 assigned from the storage pool 240. Other virtual disks may be also striped over different regions of these same physical disks, as well as other physical disks, simultaneously with virtual disk 0 212 being striped over the disks. In the example, another virtual disk 1 214 is striped over totally different physical disks for clarity. Typically, virtual disks can be composed of one or more raid arrays of either the same raid type or a mixture of raid types, each raid array being striped over the same or possibly a different subset of physical disks. Virtual disk 0 212 may be mirrored 250 to virtual disk 1 214. The controllers 230 may be configured to provide a RAID controller 234 and a storage volume manager 236. Data may even be striped across all available space in the centralized storage pool 240 thereby enabling storage to be centrally managed and shared with a heterogeneous server network.

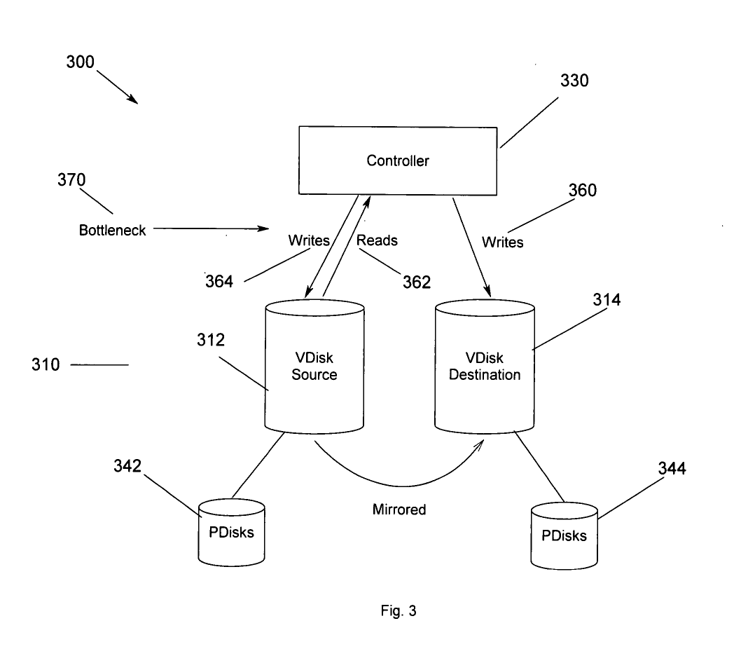

FIG. 3 is a block diagram 300 of synchronously mirrored virtual disk pairs that experience a bottleneck because of the read operations. In FIG. 3, a controller 330 virtualizes synchronously mirrored virtual disk pairs 31 as a source virtual disk 312 and a destination virtual disk 314. Each virtual disk 312, 314 shown in FIG. 3 includes a set of physical disks 342, 344. Read/write operations are performed on the source 312 of a mirror and then write operations are simply performed to the destination 314 of the mirrored RAID or VDisk. Accordingly, physical disks 344 that contain the destination RAIDs of mirror set 314 will see mostly write operations 360. However, the source 312 will see both read operations 362 and write operations 364. Because a majority of operations in storage systems are read operations 362, this tends to cause more of a bottleneck 370 on the source VDisks 312 because their physical disks 342 see more activity. Also, if another virtual disk that experiences high activity at specific periods of time happens to also be striped over the same physical disks as virtual disk 0 then those physical disks will incur higher queue depths, inducing higher queue depths on virtual disk 0 for read and write operations. It should be noted that higher queue depths presented to the virtual disk layer means higher queue depths presented to the host server, which in turn increases the latency and decreases the 10 load that a server can achieve on a virtual disk.

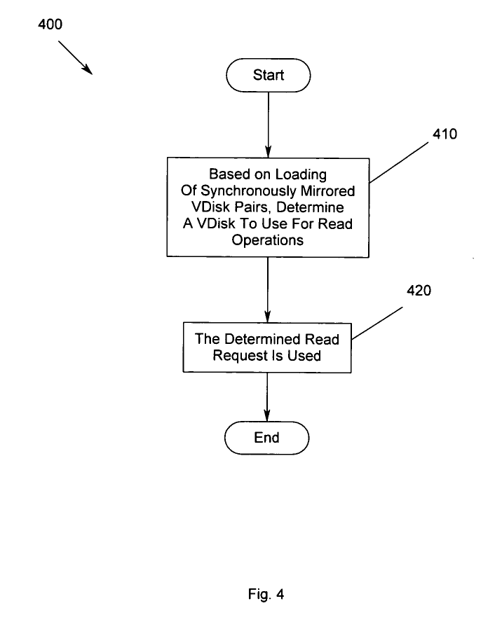

FIG. 4 is a flow chart 400 of a method for providing an optimized read methodology for synchronously mirrored virtual disk pairs according to an embodiment of the present invention. In FIG. 4, a VDisk to use for read operations is determined based on loading of synchronously mirrored VDisk pairs 410. Based on the loading, the determined request is used to satisfy the read operation 420.

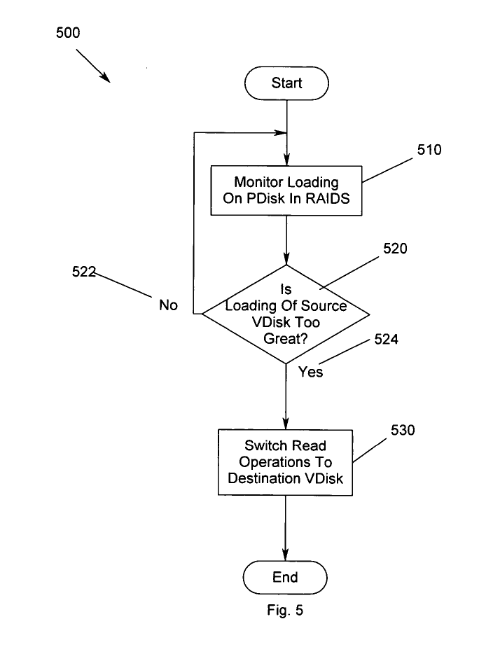

FIG. 5 is flow chart 500 of a method for providing an optimized read methodology for synchronously mirrored virtual disk pairs according to an embodiment of the present invention. In FIG. 5, the loading on the physical disks that the virtual disks are striped over is monitored 510. Then a determination is made whether the loading of the source VDisk is too great 520. Logic that is used in this determination is a combination of the instantaneous q-depths on individual physical disks, the average transfer sizes, and can include thrashing factors (how far the heads have to seek on the average over the last second), controller CPU loading, the amount of other virtual disk activity on the same physical disks, and any priorities that may have been assigned to the various virtual disks in the system. Read and write cache in the system (if available) will also enter in the calculation of loading. If the loading is not too great 522, the system continues to monitor the loading 510. If the loading is determined to be too great 524, then the read operation is switched the destination VDisk 530. Note that the same logic is used in reverse to determine when to switch back to reading from the source Virtual Disk.

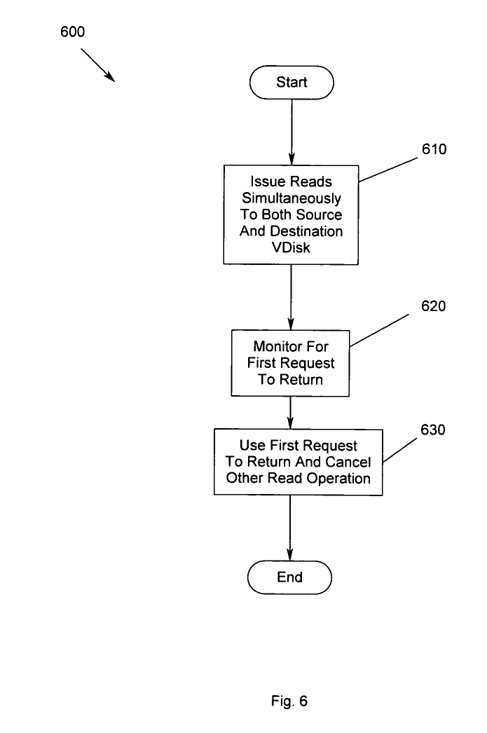

FIG. 6 is flow chart 600 of an alternate method for providing an optimized read methodology for synchronously mirrored virtual disk pairs according to an embodiment of the present invention. In FIG. 6, reads are issued simultaneously to both the source and destination VDisks 610. The VDisks are monitored for the first request to return 620. The first request to return is used and the other read operation is canceled 630. It should be noted that a request that returns in this definition can be construed as the first request to complete fully and provide data, or the first request to be moved off of a virtual disk queue. The latter interpretation is preferable in most storage systems since it will prevent unnecessary duplicate read requests making it down to the physical disk or even cache layers (if they exist). It should also be noted that this method will provide higher 10 bandwidth than the previously described method, but it typically will not be used when systems are heavily loaded.

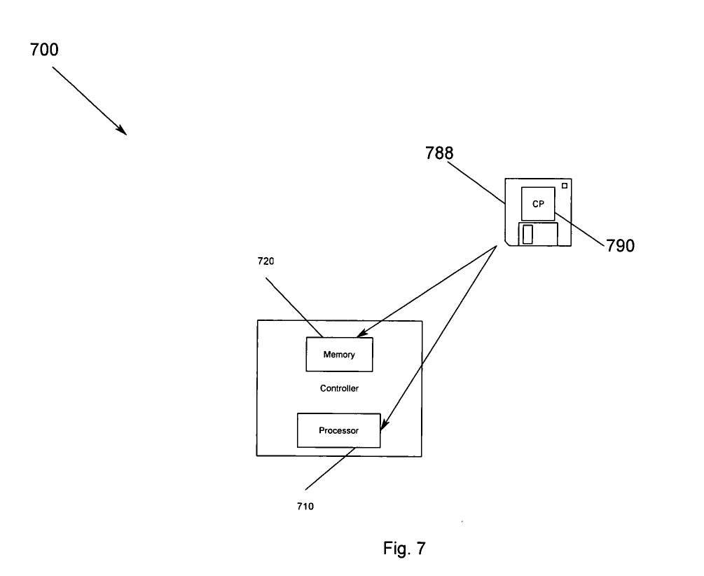

FIG. 7 illustrates a controller or system 700 is a storage system according to an embodiment of the present invention. The system 700 includes a processor 710 and memory 720. The processor controls and processes data for the storage controller 700.

The process illustrated with reference to FIGS. 1-6 may be tangibly embodied in a computer-readable medium or carrier, e.g., one or more of the fixed and/or removable data storage devices 788 illustrated in FIG. 7, or other data storage or data communications devices. The computer program 790 may be loaded into memory 720 to configure the processor 710 for execution. The computer program 790 include instructions which, when read and executed by a processor 710 of FIG. 7 causes the processor 710 to perform the steps necessary to execute the steps or elements of the present invention.

The methods described according to embodiments of the present invention may be used alone or in parallel between different mirror sets on the same system. There also exists the potential to implement this invention dynamically between controllers on different storage arrays that support the ability to create virtual links between storage arrays such that virtual disks can be mirrored from one storage array to the other, i.e., a read request may go to the local virtual disk or to the remote one if the local storage pool or controller is overloaded. Moreover, the methods described according to embodiments of the present invention improves performance and yields a new form of load balancing.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for performing read operations in a synchronously mirrored pair of virtual disks, comprising:
determining a virtual disk to use for read operations based on loading of synchronously mirrored virtual disk pairs; and
based on the loading, using the determined request to satisfy the read operation.

2. The method of claim 1, wherein the determining further comprises monitoring loading on physical disks of the virtual disks; and
determining whether the loading of the source virtual disk is too great.

3. The method of claim 2, wherein the using the determined request further comprises continuing to monitor the loading of the physical disks when loading of the source virtual disk is not too great.

4. The method of claim 2, wherein the using the determined request further comprises switching read operation to the destination virtual disk when loading of the source virtual disk is too great.

5. The method of claim 1, wherein the determining further comprises issuing reads simultaneously to both a source and destination virtual disk and monitoring the virtual disks for the first request to return.

6. The method of claim 1, wherein the using the determined request further comprises using the first request to return and canceling the read operation not returning from the source and destination virtual disk.

7. A controller for performing read operations in a synchronously mirrored pair of virtual disks, comprising:
memory for storing data and program operation instructions thereon; and
a processor, coupled to the memory, the processor being configured to determine a virtual disk to use for read operations based on loading of synchronously mirrored virtual disk pairs and based on the loading, to use the determined request to satisfy the read operation.

8. The controller of claim 7, wherein the controller determines a virtual disk to use for read operations based on loading of synchronously mirrored virtual disk pairs by monitoring loading on physical disks of the virtual disks and determining whether the loading of the source virtual disk is too great.

9. The controller of claim 8, wherein the controller continuing to monitor the loading of the physical disks when loading of the source virtual disk is not too great.

10. The controller of claim 8, wherein the controller switches read operation to the destination virtual disk when loading of the source virtual disk is too great.

11. The controller of claim 7, wherein the controller determines a virtual disk to use for read operations based on loading of synchronously mirrored virtual disk pairs by issuing reads simultaneously to both a source and destination virtual disk and monitoring the virtual disks for the first request to return.

12. The controller of claim 7, wherein the controller uses the first request to return and cancels the read operation not returning from the source and destination virtual disk.

13. A storage system, comprising:
a pool of storage devices; and
a controller, coupled to the pool of storage devices, the controller virtualizing physical disks in the pool of storage devices as virtual disks, a first virtual disk being synchronously mirrored to a second virtual disk, wherein the controller determines whether to use the first or second virtual disk for read operations based on loading of the first and second virtual disk and based on the loading, uses the determined request to satisfy the read operation.

14. The storage system of claim 13, wherein the controller determines a virtual disk to use for read operations based on loading of synchronously mirrored virtual disk pairs by monitoring loading on physical disks of the virtual disks and determining whether the loading of the source virtual disk is too great.

15. The storage system of claim 14, wherein the controller continuing to monitor the loading of the physical disks when loading of the source virtual disk is not too great.

16. The storage system of claim 14, wherein the controller switches read operation to the destination virtual disk when loading of the source virtual disk is too great.

17. The storage system of claim 13, wherein the controller determines a virtual disk to use for read operations based on loading of synchronously mirrored virtual disk pairs by issuing reads simultaneously to both a source and destination virtual disk and monitoring the virtual disks for the first request to return.

18. The storage system of claim 13, wherein the controller uses the first request to return and cancels the read operation not returning from the source and destination virtual disk.

19. A program storage device, comprising:
program instructions executable by a processing device to perform operations for performing read operations in a synchronously mirrored pair of virtual disks, the operations comprising:
determining a virtual disk to use for read operations based on loading of synchronously mirrored virtual disk pairs; and
based on the loading, using the determined request to satisfy the read operation.

20. The program storage device of claim 19, wherein the determining further comprises
monitoring loading on physical disks of the virtual disks; and
determining whether the loading of the source virtual disk is too great.

21. The program storage device of claim 20, wherein the using the determined request further comprises continuing to monitor the loading of the physical disks when loading of the source virtual disk is not too great.

22. The program storage device of claim 20, wherein the using the determined request further comprises switching read operation to the destination virtual disk when loading of the source virtual disk is too great.

23. The program storage device of claim 19, wherein the determining further comprises issuing reads simultaneously to both a source and destination virtual disk and monitoring the virtual disks for the first request to return.

24. The program storage device of claim 19, wherein the using the determined request further comprises using the first request to return and canceling the read operation not returning from the source and destination virtual disk.

25. A controller for performing read operations in a synchronously mirrored pair of virtual disks, comprising:
means for storing data and program operation instructions thereon; and
means, coupled to the means for storing data and program operation instructions, for determining a virtual disk to use for read operations based on loading of synchronously mirrored virtual disk pairs and based on the loading, for using the determined request to satisfy the read operation.

26. A controller for performing read operations in a synchronously mirrored pair of virtual disks, comprising:
memory for storing data and program operation instructions thereon; and
a processor, coupled to the memory, the processor being configured to issue the read request to both source and destination VDisks simultaneously and then process whichever read operation completes or, based on queue management, appears to be going to complete first.

27. The controller of claim 26, wherein controller issues the read request based upon virtual disk loading.

28. The controller of claim 26, wherein controller cancels a request not completing first.
